(19) United States
(12) Patent Application Publication
(10) Pub. No.: US 2014/0356703 A1
(43) Pub. Date: Dec. 4, 2014

(54) ELECTROCHEMICAL CELL COMPRISING A NANOWEB COMPRISING NANOFIBERS OF A CROSS-LINKED POLYIMIDE

(71) Applicant: E I DU PONT DE NEMOURS AND COMPANY, Wilmington, DE (US)

(72) Inventors: T. Joseph Dennes, Parkesburg, PA (US); Eric P. Holowka, Havertown, PA (US)

(21) Appl. No.: 13/908,346

(22) Filed: Jun. 3, 2013

(51) Int. Cl. H01G 11/52; H01M 2/16

(52) U.S. Cl. CPC H01G 11/52; H01M 2/162; H01M 2/1673
USPC 429/211; 361/502

(57) ABSTRACT

The invention provides an electrochemical cell comprising an electrolyte and a multi-layer article, the multi-layer article comprising a first electrode, a second electrode in ionically conductive contact with the first electrode, and a separator disposed between and in contact the first electrode and the second electrode. The separator comprises a nanoweb, the nanoweb comprising nanofibers of a cross-linked polyimide, wherein the cross-linked polyimide is derived from an aromatic dianhydride, an aromatic diamine, and a reactive end-capper. The reactive end-capper is at least one of a functionalized anhydride or a functionalized amine, functionalized with a reactive functionality selected from the group consisting of acetylene, vinyl, epoxide, nitrile, and ester. The electrochemical cell also comprises a first current collector in electrically conductive contact with the first electrode and a second current collector in electrically conductive contact with the second electrode.

### RELATED APPLICATIONS

This application is related in subject matter to the pending U.S. Provisional Patent Applications 61/635,377, 61/635,384, 61/635,389 and 61/635,392 filed on Apr. 19, 2012.

### FIELD OF THE INVENTION

The present invention is directed to a polyimide nanoweb comprising nanofibers of a cross-linked polyimide; a method of making a polyimide nanoweb; a separator comprising a polyimide nanoweb; and a multilayer article and an electrochemical cell comprising a separator.

### BACKGROUND OF THE INVENTION

Polyimides have long been valued in the market place for their combination of strength, chemical inertness in a wide variety of environments, and thermal stability. Aromatic polyimide nanowebs are one of many candidates that are being explored for use as polymeric separators for electrochemical cells, liquid and air filters, and thermal insulation materials. Polyimide nanowebs are an excellent choice for high flux and/or high filtration efficiency applications due to relatively small pores and high porosity.

Currently, polyimide nanowebs are made by solution spinning processing of polyamic acid using various techniques such as, electrospinning, electroblowing, and centrifugal spinning. These processes require rheological properties of the polyamic acid solution to be in a specific range in order to form a nanoweb having fiber size distribution in the desired range. The rheological properties of the polyamic acid solution are controlled by the polyamic acid molecular weight and the solution concentration. Furthermore, the molecular weight of the polyamic acid solution impacts the mechanical properties of the nanoweb produced therefrom. Hence, the polyamic acid solution must have a molecular weight above a certain critical value in order to produce a nanoweb with suitable mechanical properties. However, high concentration solutions of high molecular weight polyamic acid are typically too viscous to be compatible with the solution spinning processes.

Hence, there is a need for a new method for making polyimide nanowebs with suitable mechanical properties from high concentration solutions; polyimide nanowebs comprising nanofibers of a cross-linked polyimide; separator comprising polyimide nanowebs; and multilayer articles and electrochemical cells comprising separator.

U.S. Pat. No. 7,129,318 discloses polyimide resins suitable for processing by resin transfer molding and resin infusion methods as reduced processing temperatures.

### SUMMARY OF THE INVENTION

In an aspect of the invention, there is a nanoweb comprising nanofibers of a cross-linked polyimide, wherein the cross-linked polyimide is derived from an aromatic dianhydride, an aromatic diamine, and a reactive end-capper.

In an aspect, the reactive end-capper is at least one of a functionalized anhydride or a functionalized amine, functionalized with a reactive functionality selected from the group consisting of acetylene, vinyl, epoxide, nitrile, and ester.

In an aspect, the reactive end-capper is an acetylene-functionalized phthalic anhydride.

In an aspect, the acetylene-functionalized phthalic anhydride is selected from the group consisting of 4-phenylethynylphthalic anhydride (PEPA), ethynyl phthalic anhydride (EPA), pyromellitic ethynyl phthalic anhydride (PETA), methyl ethynyl phthalic anhydride (MEPA), and mixtures thereof.

In another aspect of the invention, there is a nanoweb comprising nanofibers of a cross-linked polyimide, wherein the cross-linked polyimide comprises a cyclotrimerized aromatic polyimide and wherein the cross-linked polyimide is derived from an aromatic dianhydride, an aromatic diamine, and an acetylene-functionalized phthalic anhydride.

In an aspect, the cross-linked polyimide is derived from pyromellitic dianhydride (PMDA), oxydianiline (ODA), and an acetylene-functionalized phthalic anhydride.

In an aspect, the cyclotrimerized aromatic polyimide has the following general structure:

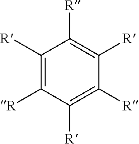

wherein R″ comprises at least one of hydrogen, methyl, phenyl, or phthalic anhydride and R′ comprises at least one of:

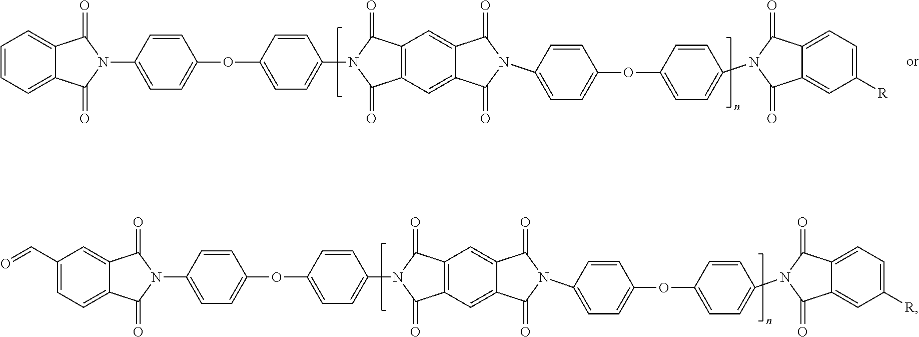

and

wherein R comprises at least one of, acetylene, etyhynyl benzene, 3-phenyl-2-propynal, ethynyl phthalic anhydride, or propyne.

In an aspect of the invention, there is a method comprising:

(a) reacting an aromatic dianhydride with an aromatic diamine in an aprotic solvent to form a non end-capped polyamic acid;

(b) adding a reactive end-capper to the non end-capped polyamic acid to form a reactive end-capped polyamic acid;

(c) processing a solution comprising the reactive end-capped polyamic acid to form a polyamic acid nanoweb comprising nanofibers of the reactive end-capped polyamic acid; and

(d) thermally converting the polyamic acid nanoweb comprising nanofibers of the reactive end-capped polyamic acid to a polyimide nanoweb comprising nanofibers of a cross-linked polyimide.

In an aspect of the invention, there is a method comprising:

(a) reacting an aromatic dianhydride with an aromatic diamine present in a molar ratio of 0.85:1 to 0.98:1 in an aprotic solvent to form a non end-capped polyamic acid;

(b) adding an acetylene-functionalized phthalic anhydride to the non end-capped polyamic acid in an amount of 1-30% of the molar amount of the aromatic diamine to form an acetylene end-capped polyamic acid;

(c) processing a solution comprising 15-35 weight % of the acetylene end-capped polyamic acid form a polyamic acid nanoweb comprising nanofibers of the acetylene end-capped polyamic acid; and

(d) thermally converting the polyamic acid nanoweb comprising nanofibers of the acetylene end-capped polyamic acid to a polyimide nanoweb comprising nanofibers of a cross-linked polyimide.

In an aspect, there is a separator for an electrochemical cell comprising a nanoweb, the nanoweb comprising nanofibers of a cross-linked polyimide, wherein the cross-linked polyimide is derived from an aromatic dianhydride, an aromatic diamine, and a reactive end-capper.

In an aspect, the invention provides a multi-layer article for an electrochemical cell, the multi-layer article comprising:

(a) a first electrode;

(b) a second electrode; and

(c) a separator disposed between and in contact with the first electrode and the second electrode, the separator comprising:

a nanoweb, the nanoweb comprising nanofibers of a cross-linked polyimide, wherein the cross-linked polyimide is derived from an aromatic dianhydride, an aromatic diamine, and a reactive end-capper.

In an aspect, the invention provides an electrochemical cell comprising:

(a) an electrolyte;

(b) a multilayer article, the multilayer article comprising a first electrode, a second electrode in ionically conductive contact with the first electrode, and a separator disposed between and in contact with the first electrode and the second electrode, the separator comprising:
a nanoweb, the nanoweb comprising nanofibers of a cross-linked polyimide, wherein the cross-linked polyimide is derived from an aromatic dianhydride, an aromatic diamine, and a reactive end-capper;

(c) a first current collector in electrically conductive contact with the first electrode; and

(d) a second current collector in electrically conductive contact with the second electrode.

### BRIEF DESCRIPTION OF THE DRAWINGS

FIG. 1 schematically illustrates a cross-sectional view of a portion of a multi-layer article, in accordance with various embodiments of the present invention.

FIG. 2 shows a schematic illustration of a cross-sectional view of a portion of a multi-layer article, in accordance with various embodiments of the present invention.

FIG. 3 schematically illustrates a perspective view of a multi-layer article in the form of a prismatic stack, in accordance with various embodiments of the present invention.

FIG. 4 schematically illustrates a perspective view of a multi-layer article in the form of a spiral stack, in accordance with various embodiments of the present invention.

FIG. 5 schematically illustrates a cross-sectional view of an electrochemical cell, in accordance with various embodiments of the present invention.

FIG. 6 schematically illustrates a cross-sectional view of another embodiment of an electrochemical cell of the present invention.

FIG. 7 shows an infrared (IR) spectrum of a polyimide nanoweb derived from a polyamic acid having a stoichiometry of 97%.

FIG. 8 shows an infrared (IR) spectrum of an exemplary polyimide nanoweb derived from a polyamic acid having a stoichiometry of 89%, the polyimide nanoweb comprising nanofibers of a cross-linked polyimide, in accordance with various embodiments of the present invention.

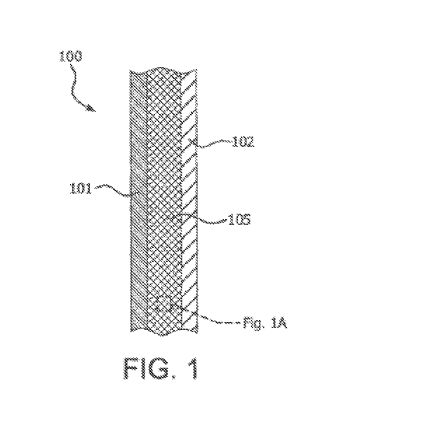

### REFERENCE NUMERALS SHOWN IN FIGS. 1-6 ARE EXPLAINED BELOW:

100, 200, 500: multi-layer article
300: multi-layer article in the form of a prismatic stack
400: multi-layer article in the form of a spiral stack
550, 650: electrochemical cell
600a, 600b, 600c: individual cells in an electrochemical cell
101, 201, 301, 301′, 401, 401′, 501, 601, 601′: first electrode
102, 202, 302, 302′, 402, 402′, 502, 602, 602′: second electrode
105, 205, 305, 305′, 405, 405′, 505, 605, 605′: separator
311, 411, 511, 611, 611′: a first current collector
312, 412, 512, 612, 612′: a second current collector

### DESCRIPTION OF THE INVENTION

For the purposes of the present invention, Table 1 shows the abbreviations and designations of some of the commonly used dianhydrides and diamines, consistent with the practice in the polyimide art:

TABLE 1

| Abbreviation | Chemical Name | Chemical Structure |
|---|---|---|
| PMDA | Pyromellitic Dianhydride | 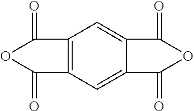 PMDA |
| BPDA | Biphenyltetracarboxylic Dianhydride | 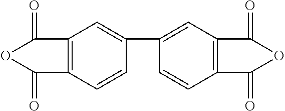 BPDA |
| ODA | Oxydianiline | 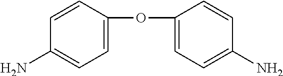 |
| RODA | 1,3-bis(4- aminophenoxy)benzene | 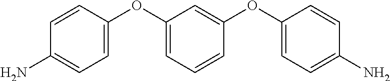 |
| PDA | 1,4 phenylenediamine | 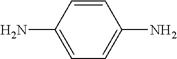 |
| TDI | 2,4-toluene diisocyanate and 2,6 toluene diisocyanate | 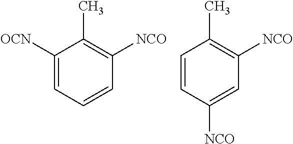 |
| MDI | Methylene diphenyl 4,4′-diisocyanate | 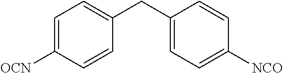 |
| BTDA | 3,3′,4,4′-benzophenone tetracarboxylic dianhydride | 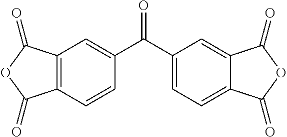 |

In an aspect of the invention, there is a polyimide nanoweb comprising nanofibers of a cross-linked polyimide, wherein the cross-linked polyimide is derived from an aromatic dianhydride, an aromatic diamine, and a reactive end-capper.

As used herein, the term “nanoweb” refers to a nonwoven web constructed predominantly of nanofibers. “Predominantly” means that greater than 50% by number, of the fibers in the web are nanofibers, where the term “nanofibers” as used herein refers to fibers having a number average diameter of less than 1000 nm, even less than 800 nm, even between 50 nm and 800 nm, and even between 100 nm and 400 nm. In the case of non-round cross-sectional nanofibers, the term “diameter” as used herein refers to the greatest cross-sectional dimension. The nanoweb of the present invention can have greater than 70%, or 90% or it can even contain 100% of nanofibers.

For the purposes of the present invention, a suitable polyimide nanoweb is characterized by a porosity in the range of 20-95% or 30-60%, as determined by measured basis weight and thickness in ASTM D3776 and D1777, respectively.

In an embodiment of the polyimide nanoweb, the polyimide is a fully aromatic polyimide.

Suitable aromatic dianhydrides include but are not limited to pyromellitic dianhydride (PMDA); biphenyltetracarboxylic dianhydride (BPDA); 3,3′,4,4′-benzophenone tetracarboxylic dianhydride (BTDA); and mixtures thereof.

Suitable aromatic diamines include but are not limited to oxydianiline (ODA); 1,3-bis(4-aminophenoxy)benzene (RODA); 1,4 phenylenediamine (PDA); and mixtures thereof.

As used herein, the term “reactive end-capper” is defined as a molecule which can be added to a polyamic acid at the end of the synthetic procedure, as shown in the reaction scheme (1) to react with free end groups, such as amines or anhydrides. Furthermore, the reactive end-capper must have an additional reactive functionality that can be activated via an external “trigger” mechanism, such as, thermal, UV exposure, or plasma treatment, to allow an increase in molecular weight of the polymer. Suitable classes of end-cappers include, but are not limited to, functionalized anhydrides and functionalized amines, functionalized with a reactive functionality selected from the group consisting of acetylene, vinyl, epoxide, nitrile, and ester.

Suitable reactive end-cappers include, but are not limited to a functionalized anhydride or a functionalized amine, functionalized with a reactive functionality selected from the group consisting of acetylene, vinyl, epoxide, nitrile, and ester.

In an embodiment, the reactive end-capper is an acetylene-functionalized phthalic anhydride. In another embodiment, the acetylene-functionalized phthalic anhydride is selected from the group consisting of 4-phenylethynylphthalic anhydride (PEPA), ethynyl phthalic anhydride (EPA), pyromellitic ethynyl phthalic anhydride (PETA), methyl ethynyl phthalic anhydride (MEPA), and mixtures thereof.

In an embodiment of the polyimide nanoweb, the cross-linked polyimide is derived from pyromellitic dianhydride (PMDA), oxydianiline (ODA), and an acetylene-functionalized phthalic anhydride.

In an embodiment, the cross-linked polyimide comprises a cyclotrimerized aromatic polyimide I. In another embodiment, the cyclotrimerized polyimide I has the following general structure:

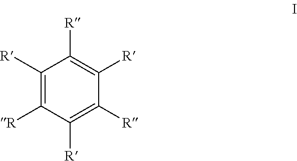

wherein R″ comprises at least one of hydrogen, methyl, phenyl, or phthalic anhydride and R′ comprises at least one of:

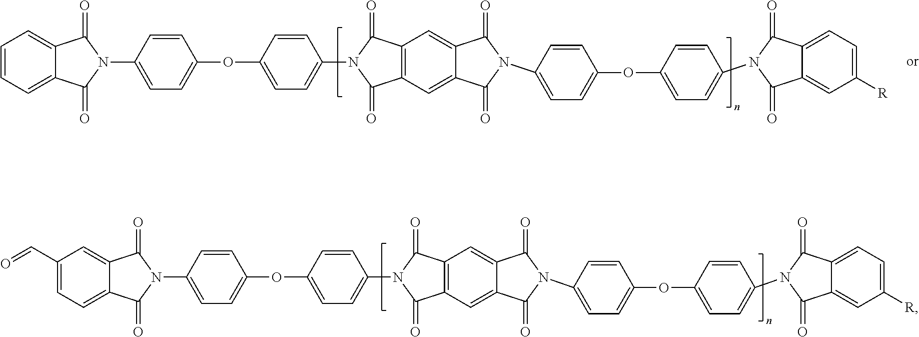

and

wherein R comprises at least one of, acetylene, ethynyl benzene, 3-phenyl-2-propynal, ethynyl phthalic anhydride, or propyne.

In an embodiment, the cross-linked polyimide comprises at least one of 1,3,5-tripolyimide benzene; 1,3,5-tripolyimide-2,4,6-triphenyl benzene; 1,3,5-tripolyimide-2,4,6-trimethyl benzene; 1,3,5-tripolyimide-2,4,6-(isobenzofuran-1,3-dione); or mixtures thereof.

In one embodiment of the polyimide nanoweb, the cross-linked polyimide is derived from an aromatic dianhydride, an aromatic diamine, and an acetylene-functionalized phthalic anhydride present in a molar ratio of 0.85:1.0:0.30 to 0.95:1.0:0.01 or 0.88:1.0:0.24 to 0.95:1.0:0.02. The resulting polyimide nanoweb has a break stress of at least 200 Kg/cm² or at least 330 Kg/cm².

In an embodiment, the nanofibers of the cross-linked polyimide of the present invention comprises more than 80 wt % of one or more fully aromatic polyimides, more than 90 wt % of one or more fully aromatic polyimides, more than 95 weight % of one or more fully aromatic polyimides, more than 99 wt % of one or more fully aromatic polyimides, more than 99.9 wt % of one or more fully aromatic polyimides, or 100 wt % of one or more fully aromatic polyimides. As used herein, the term “fully aromatic polyimide” refers specifically to polyimides in which at least 95% of the linkages between adjacent phenyl rings in the polymer backbone are effected either by a covalent bond or an ether linkage. Up to 25%, preferably up to 20%, most preferably up to 10%, of the linkages can be effected by aliphatic carbon, sulfide, sulfone, phosphide, or phosphone functionalities or a combination thereof. Up to 5% of the aromatic rings making up the polymer backbone can have ring substituents of aliphatic carbon, sulfide, sulfone, phosphide, or phosphone. Preferably the fully aromatic polyimide suitable for use in the present contains no aliphatic carbon, sulfide, sulfone, phosphide, or phosphone.

In some embodiments, the nanofibers may comprise 0.1-10 wt % of non fully-aromatic polyimides such as P84® polyimide available Evonik Industries (Lenzing, Austria); non fully-aromatic polymers from diaminodiphenyl methane as monomer, and/or other polymeric components such as polyolefins. P84® polyimide is a condensation polymer of 2,4-diisocyanato-1-methylbenzene and 1-1′-methylenebis[4-isocyanatobenzene] with 5-5′carbonylbis[1,3-isobenzofurandione], having the following structure:

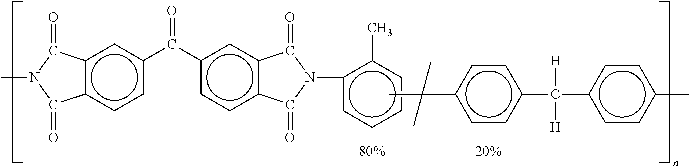

In an aspect of the invention, there is provided a method of making a polyimide nanoweb comprising reacting an aromatic dianhydride with an aromatic diamine to form a non end-capped polyamic acid; and adding a reactive end-capper to the non end-capped polyamic acid to form a reactive end-capped polyamic acid. The method also comprises processing a solution of the reactive end-capped polyamic acid to form a polyamic acid nanoweb comprising nanofibers of the reactive end-capped polyamic acid; and thermally converting the polyamic acid nanoweb to a polyimide nanoweb comprising nanofibers of a cross-linked polyimide.

In an embodiment, the method comprises reacting an aromatic dianhydride II with an aromatic diamine III present in a molar ratio in the range of 0.85:1 to 0.98:1 or 0.88:1 to 0.95:1, in an aprotic polar solvent at low to moderate temperatures to form a non end-capped polyamic acid IV, as shown in the reaction scheme (1):

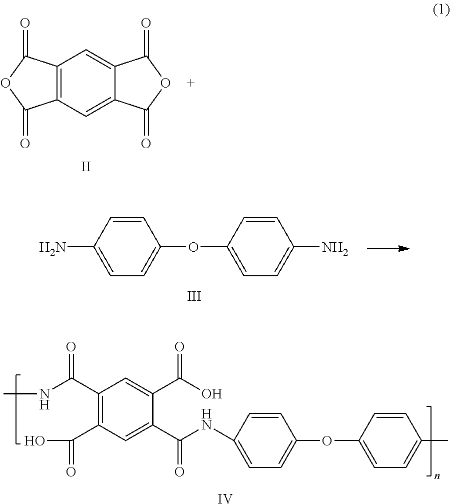

Suitable aromatic dianhydrides II include but are not limited to pyromellitic dianhydride (PMDA); biphenyltetracarboxylic dianhydride (BPDA); 3,3′,4,4′-benzophenone tetracarboxylic dianhydride (BTDA); and mixtures thereof. Suitable aromatic diamines III include but are not limited to oxydianiline (ODA); 1,3-bis(4-aminophenoxy)benzene (RODA); 1,4 phenylenediamine (PDA); and mixtures thereof.

Any suitable aprotic polar solvent can be used in the synthesis of non end-capped polyamic acid IV, in the reaction scheme (1). A suitable organic solvent acts as a solvent for the polyamic acid and at least one of the reactants. A suitable solvent is inert to the reactants (the dianhydrides II or the diamines III). In one embodiment, the aprotic polar solvent is a solvent for the non end-capped polyamic acid IV and both the dianhydride II and the diamine III. The normally liquid organic solvents of the N,N-dialkylcarboxylamide class are useful as solvents in the method of this invention. Exemplary solvents include, but are not limited to, N,N-dimethylformamide (DMF) and N,N-dimethylacetamide (DMAC), N,N-diethylformamide, N,N-diethylacetamide, N,N-dimethylmethoxyacetamide, N-methyl-2-pyrrolidone (NMP), N-methylcaprolactam, and the like. Other solvents which can be used in the present invention are: dimethylsulfoxide (DMSO), tetramethyl urea, pyridine, dimethylsulfone, hexamethylphosphoramide, tetramethylene sulfone, formamide, N-methylformamide, butyrolactone, and N-acetyl2-pyrrolidone. The solvents can be used alone, in combinations of solvents, or in combination with poor solvents such as benzene, benzonitrile, dioxane, xylene, toluene, and cyclohexane.

The method of making a polyimide nanoweb further comprises adding a reactive end-capper to the non end-capped polyamic acid to form a reactive end-capped polyamic acid.

Suitable reactive end-cappers include, but are not limited to a functionalized anhydride or a functionalized amine, functionalized with a reactive functionality selected from the group consisting of acetylene, vinyl, epoxide, nitrile, and ester.

In an embodiment, the reactive end-capper is an acetylene-functionalized phthalic anhydride. In another embodiment, the method of making a polyimide nanoweb comprises adding an acetylene-functionalized phthalic anhydride V to the non end-capped polyamic acid IV to form an acetylene end-capped polyamic acid VI, as shown below in the reaction scheme (2). The acetylene-functionalized phthalic anhydride V is a reactive end-capper that end-caps the polyamic acid IV with cross-linkable end-groups, such as acetylene.

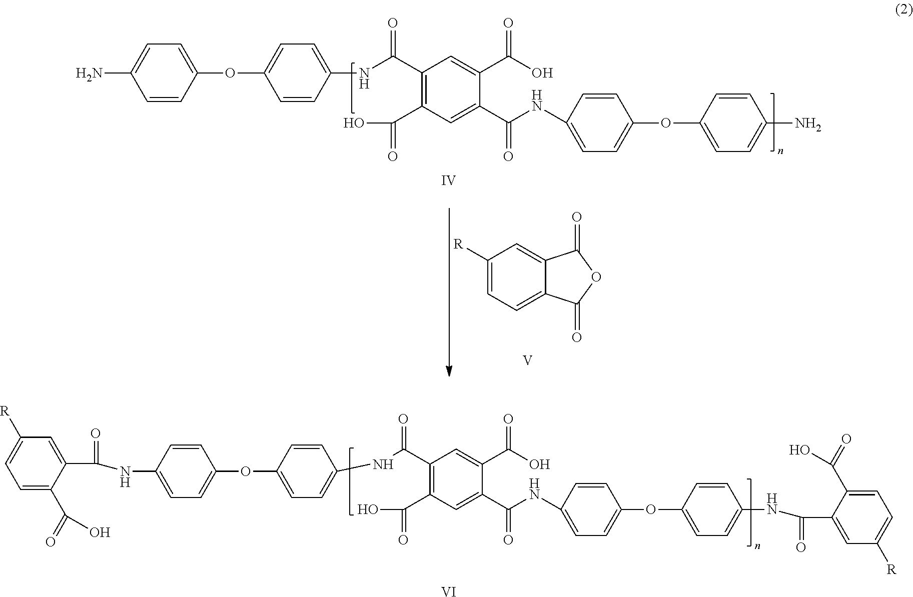

wherein R comprises at least one of, acetylene, ethynyl benzene, 3-phenyl-2-propynal, ethynyl phthalic anhydride, propyne, as shown below and the like:

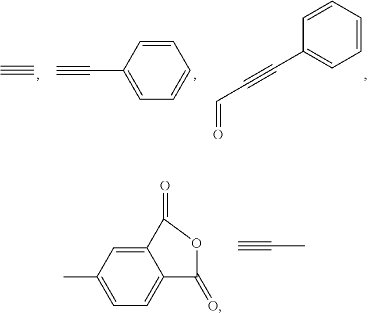

Suitable acetylene-functionalized phthalic anhydride V is selected from the group consisting of 5-ethynyl isobenzofuran-1,3-dione (EPA); phenylethynyl phthalic anhydride (PEPA); phenylethynyl trimellitic anhydride (PETA); methyl ethynyl phthalic anhydride (MEPA), and mixtures thereof.

The molecular weight of the acetylene end-capped polyamic acid VI obtained from the reaction scheme (2) is dependent upon several factors, such as, purity of the monomers, relative amounts of aromatic anhydride and aromatic diamine, extent of moisture exclusion, choice of solvent, and maintenance of low to moderate temperatures. Reaction (2) can be performed at temperatures up to 175° C., but preferably at temperatures below 75° C. The temperature limitation results from three possible reactions which would limit molecular weight: (a) partial conversion to polyimide, releasing water which would hydrolyze the polyamic acid; (b) extensive conversion to polyimide above 100° C., which, in addition to hydrolysis, could result in premature precipitation of low-molecular weight polymer out of the reaction medium; and (c) possible transamidation with the solvents.

Table 4, described infra, summarizes the effect of monomer stoichiometry on the molecular weight of the non end-capped polyamic acid. In general, as the relative amounts of aromatic dianhydride II to aromatic diamine III is increased from 93% to 98%, the weight average molecular weight of the polyamic acid is also increased. Similar effect of monomer stoichiometry is expected for the acetylene end-capped polyamic acid.

In an embodiment, the acetylene end-capped polyamic acid VI has a weight average molecular weight in the range of 2,000-50,000 g/mol or 4,000-30,000 g/mol. In another embodiment, the acetylene end-capped polyamic acid VI has a weight average molecular weight of less than 12,000 g/mol.

The method of making a polyimide nanoweb further comprises processing a solution comprising 15-35 weight % of the acetylene end-capped polyamic acid VI to form a polyamic acid nanoweb comprising nanofibers of the acetylene end-capped polyamic acid VI. In an embodiment, the step of processing a solution of the acetylene end-capped polyamic acid comprises using at least one of electroblowing, electrospinning, or centrifugal spinning. The acetylene end-capped polyamic acid VI is first prepared in solution; typical solvents are dimethylacetamide (DMAC) or dimethylformamide (DMF) which are also used as solvents for the monomers. In an embodiment, the solution for processing has 20-32 weight % of the acetylene end-capped polyamic acid VI. One of the important parameters of solution spinning processes is viscosity of the solution, which can affect resultant fiber size and also the laydown of the nanofibers prior to forming a nanoweb. The viscosity of the solution in turn is dependent upon the amount of acetylene end-capped polyamic acid VI in the solution which is related to the molecular weight of the acetylene end-capped polyamic acid VI, and which in turn also depends upon the stoichiometry, besides other factors. Table 3 described infra, shows that a 25 weight % solution comprising an acetylene end-capped polyamic acid having 93% stoichiometry has a lower viscosity than a 20 weight % solution comprising an acetylene end-capped polyamic acid having 97% stoichiometry (4.2 Pa·s versus 8.4 Pa·s).

In one method suitable for the practice of the invention, the solution of the acetylene end-capped polyamic acid VI is formed into a nanoweb by electroblowing, as described in Kim et al., U.S. Published Patent Application 2005/0067732. In an alternative method suitable for the practice of the invention, the solution of the acetylene end-capped polyamic acid is formed into a nanoweb by electrospinning as described in Huang et al., Adv. Mat. DOI: 10.1002/adma.200501806.

In an embodiment, at least 50% increase in nanoweb production is observed if a 30 weight % solution of the acetylene end-capped polyamic acid VI is used in solution spinning processes such as, electroblowing, electrospinning, or centrifugal spinning as compared to using a 20 weight % conventional polyamic acid, based solely on the increased polymer concentration.

The method of making a polyimide nanoweb also comprises converting the polyamic acid nanoweb comprising nanofibers of the reactive end-capped polyamic acid to a polyimide nanoweb comprising nanofibers of a cross-linked polyimide. The step of converting the polyamic acid nanoweb to a polyimide nanoweb may be a multi-step process comprising imidization of the polyamic acid to polyimide and activation of the reactive functionalities of the reactive end-cappers. Any suitable method for activation of the reactive functionality of the reactive end-capper may be used, such as thermal treatment, UV exposure, and plasma treatment. Imidization of the polyamic acid to polyimide may be accomplished chemically or thermally. In an embodiment, the method comprises thermally converting the polyamic acid nanoweb comprising nanofibers of the acetylene end-capped polyamic acid VI to a polyimide nanoweb comprising nanofibers of a cross-linked polyimide, wherein the cross-linked polyimide comprises a cyclotrimerized aromatic polyimide I, as shown below in the reaction scheme (3). While not bound by any specific theory, it is believed that there are other possible reaction schemes for cross-linking, besides the cyclotrimerization shown here in the reaction scheme (3), such as, via formation of alkenyl esters, central arylene ethers, alkenyl imidate, and N-alkenyl amide.

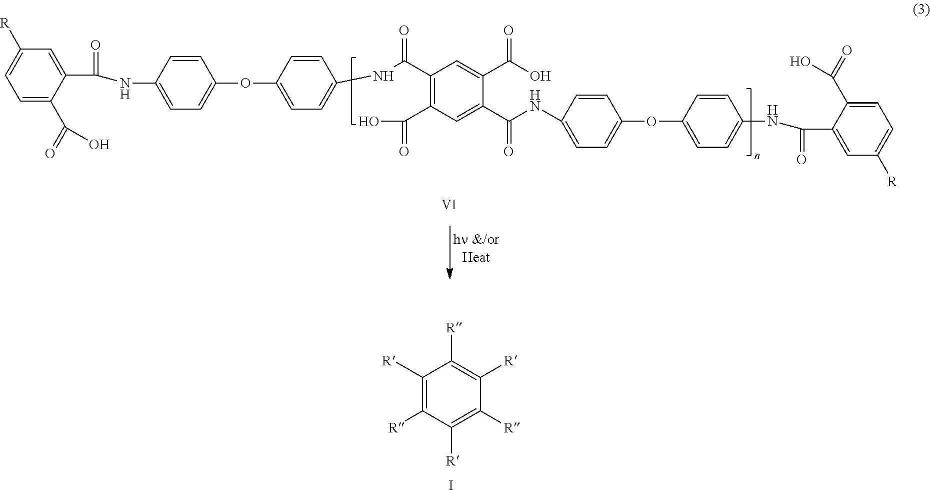

wherein R″ comprises at least one of hydrogen, methyl, phenyl, or phthalic anhydride and R comprises at least one of acetylene, ethynyl benzene, 3-phenyl-2-propynal, ethynyl phthalic anhydride, or propyne, as shown below:

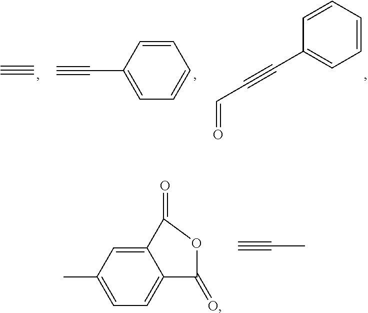

wherein R′ comprises at least one of:

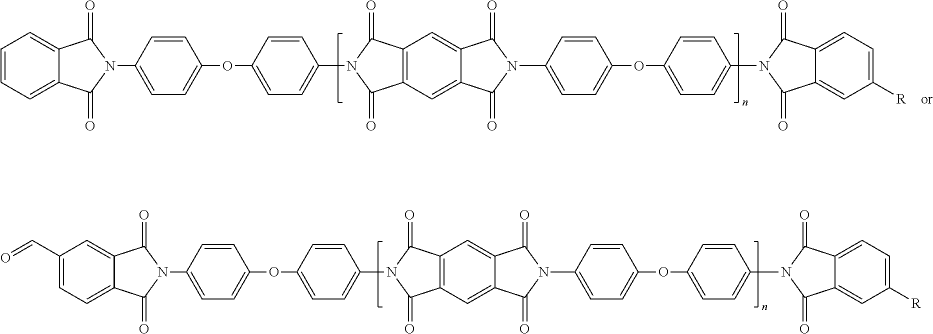

In an embodiment, the step of thermally converting polyamic acid nanoweb to polyimide nanoweb is a two-step process. The first step comprises imidizing the acetylene end-capped polyamic acid VI at 350° C. for 2-10 minutes to form an acetylene end-capped polyimide. The second step comprises annealing the acetylene end-capped polyimide at 450° C. for 2-10 minutes to form a cross-linked polyimide comprising a cyclotrimerized aromatic polyimide I.

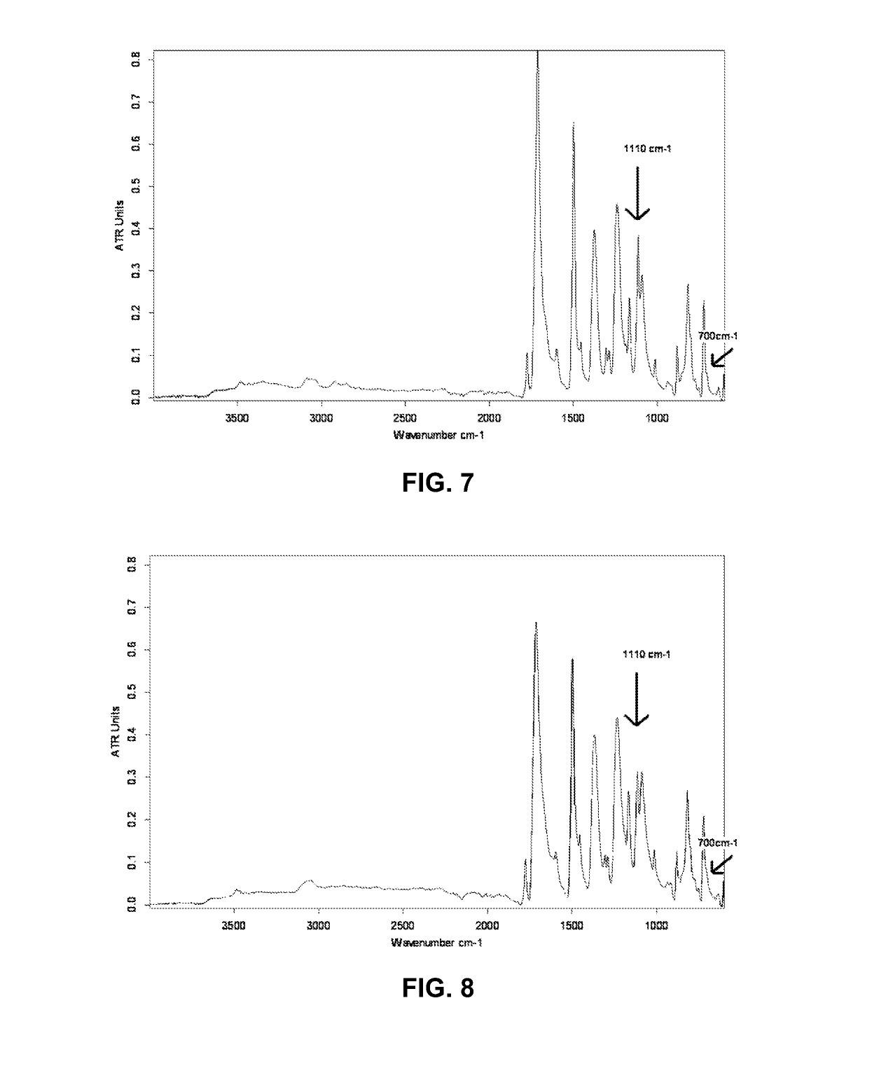

As shown in the reaction scheme (3), the cross-linked polyimide comprises a cyclotrimerized aromatic polyimide I with an aromatic ring being an anchor point of the trimer. This is evident by comparing infrared (IR) spectrum of a polyimide control formed without an end-capper with that of a cross-linked polyimide, as shown in FIGS. 7 and 8 respectively. When a polyimide is end-capped and cross-linked, the cross-link points become 1,3,5 trisubstituted benzene rings. Hence, the intensity of the peak at 1110 cm⁻¹, which corresponds to the in-plane bending of para-substituted benzene rings decreases in intensity for the cross-lined polyimide, as compared to that of control polyimide. Comparing FIGS. 7 and 8 shows that the peak height ratio of the peak at 1110 cm⁻¹ to a control background peak at 1500 cm⁻¹ is decreased by approximately 30% in the spectrum of the cross-linked polyimide shown in FIG. 8 compared to the control polyimide shown in FIG. 7. In addition, a peak at 700 cm⁻¹, which is representative of ring bending for 1,3,5 substituted aromatics is developed as a shoulder in the spectrum of the cross-linked polyimide. The peak height ratio of this shoulder (compared to the background peak at 1500 cm⁻¹) increases by approximately 50% in the spectrum of cross-linked polyimide as shown in FIG. 8 compared to control polyimide shown in FIG. 7.

The step of thermally converting the polyamic acid nanoweb to a polyimide nanoweb can be performed using any suitable technique, such as, heating in a convection oven, vacuum oven, infra-red oven in air or in inert atmosphere such as argon or nitrogen.

In one embodiment, the polyamic acid nanoweb is heated in a multi-zone infra-red oven with each zone set to a different temperature. In an alternative embodiment, all the zones are set to the same temperature. In another embodiment the infrared oven further comprises an infra-red heater above and below a conveyor belt. It should be noted that the temperature of each zone is determined by the particular polyamic acid, time of exposure, fiber diameter, emitter to emitter distance, residual solvent content, purge air temperature and flow, fiber web basis weight (basis weight is the weight of the material in grams per square meter). For example, conventional annealing range is 400-500° C. for PMDA/ODA, but is around 200° C. for BPDA/RODA; BPDA/RODA will decompose if heated to 400° C. Also, one can shorten the exposure time, but increase the temperature of the infra-red oven and vice versa.

In an embodiment, the nanofibers of a cross-linked polyimide of this invention comprise more than 80 weight % of one or more fully aromatic polyimides, more than 90 weight % of one or more fully aromatic polyimides, more than 95 weight % of one or more fully aromatic polyimides, more than 99 weight % of one or more fully aromatic polyimides, more than 99.9 weight % of one or more fully aromatic polyimides, or 100 weight % of one or more fully aromatic polyimides. As used herein, the term “fully aromatic polyimide” refers specifically to polyimides in which the ratio of the imide C—N infrared absorbance at 1375 cm⁻¹ to the p-substituted C—H infrared absorbance at 1500 cm⁻¹ is greater than 0.51 and wherein at least 95% of the linkages between adjacent phenyl rings in the polymer backbone are effected either by a covalent bond or an ether linkage. Up to 25%, preferably up to 20%, most preferably up to 10%, of the linkages can be effected by aliphatic carbon, sulfide, sulfone, phosphide, or phosphone functionalities or a combination thereof. Up to 5% of the aromatic rings making up the polymer backbone can have ring substituents of aliphatic carbon, sulfide, sulfone, phosphide, or phosphone. Preferably the fully aromatic polyimide suitable for use in the present contains no aliphatic carbon, sulfide, sulfone, phosphide, or phosphone.

Aromatic polyimide nanowebs of the present invention are suitable for use as separators for electrochemical cells, liquid and air filters, and thermal insulation materials. Polyimide nanowebs are an excellent choice for high flux, high filtration efficiency applications due to relatively small pores and high porosity. In addition, polyimide nanowebs provide many benefits when used as separators for electrochemical cells including, but not limited to, high-temperature stability and a suitable critical surface tension due to polymer surface energy and nonwoven morphology, which enables wetting with organic electrolyte solutions such as LiPF₆ in ethylene carbonate/ethyl methyl carbonate.

In an aspect, there is a separator for an electrochemical cell comprising a nanoweb disclosed herein above, the nanoweb comprising nanofibers of a cross-linked polyimide, wherein the cross-linked polyimide is derived from an aromatic dianhydride, an aromatic diamine, and a reactive end-capper.

In an embodiment, the reactive end-capper is an acetylene-functionalized phthalic anhydride selected from the group consisting of 4-phenylethynylphthalic anhydride (PEPA), ethynyl phthalic anhydride (EPA), pyromellitic ethynyl phthalic anhydride (PETA), methyl ethynyl phthalic anhydride (MEPA), and mixtures thereof.

In another embodiment, the separator for an electrochemical cell comprises a nanoweb disclosed herein above, the nanoweb comprising nanofibers of a cross-linked polyimide, wherein the cross-linked polyimide comprises a cyclotrimerized aromatic polyimide I, and wherein the cross-linked polyimide is derived from an aromatic dianhydride II, an aromatic diamine III, and an acetylene-functionalized phthalic anhydride IV.

In an aspect of the invention, there is a multi-layer article comprising a first electrode, a second electrode, and a separator disposed between and in contact with the first electrode and the second electrode, the separator comprising a nanoweb disclosed herein above, the nanoweb comprising nanofibers of a cross-linked polyimide, wherein the cross-linked polyimide is derived from an aromatic dianhydride II, an aromatic diamine III, and a reactive end-capper IV.

In an embodiment, there is a multi-layer article comprising a first electrode, a second electrode, and a separator disposed between and in contact with the first electrode and the second electrode, the separator comprising a nanoweb disclosed herein above, the nanoweb comprising nanofibers of a cross-linked polyimide, wherein the cross-linked polyimide comprises a cyclotrimerized aromatic polyimide I, wherein the cross-linked polyimide is derived from an aromatic dianhydride II, an aromatic diamine III, and an acetylene-functionalized phthalic anhydride IV.

FIG. 1 schematically illustrates a cross-sectional view of a portion of a multi-layer article, 100, in accordance with an embodiment of the present invention. The multi-layer article, 100 comprises a first electrode, 101, a second electrode, 102, and a separator, 105 disposed between and in contact with the first electrode, 101 and the second electrode, 102. The separator, 105 comprises a nanoweb disclosed herein above, the nanoweb comprising nanofibers of a cross-linked polyimide. In an embodiment, the cross-linked polyimide comprises a cyclotrimerized aromatic polyimide I.

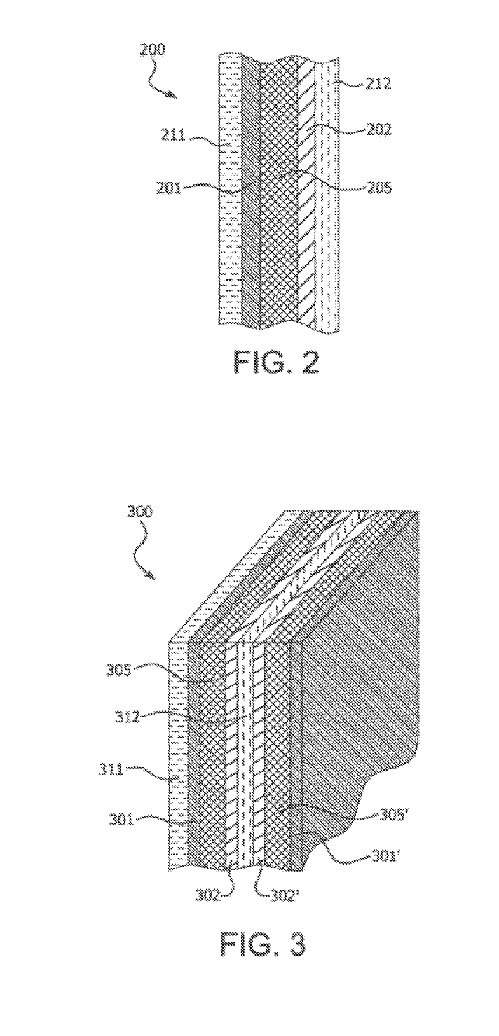

FIG. 2 schematically illustrates a cross-sectional view of a portion of another embodiment of a multi-layer article, 200. The multi-layer article, 200 comprises a first electrode, 201; a first current collector, 211 in electrically conductive contact with the first electrode, 201; a second electrode, 202; a second current collector, 212 in electrically conductive contact with the second electrode, 202, and a separator, 205 disposed between and in contact with the first electrode, 201 and the second electrode, 202. The separator, 205 comprises a nanoweb disclosed herein above, the nanoweb comprising nanofibers of a cross-linked polyimide. In an embodiment, the cross-linked polyimide comprises a cyclotrimerized aromatic polyimide I.

In one embodiment of the multi-layer article, 100, 200, the nanofibers, 106, as shown in FIG. 1A, are characterized by a number average diameter of less than 1000 nm. In an embodiment, the nanofibers, 106 are characterized by a number average diameter in the range of 50-800 nm. In a further embodiment, the nanofibers, 106 are characterized by a number average diameter in the range of 100-400 nm.

In one embodiment of the multi-layer article, 100,200, the polyimide is a fully aromatic polyimide. In a further embodiment, the fully aromatic polyimide is derived from PMDA, ODA, and an acetylene-functionalized phthalic anhydride.

In an embodiment, the first electrode, 101, 201 and the second electrode, 102, 202 have different material composition in an embodiment, and the multi-layer article 100, 200 hereof is useful in batteries, such as lithium-ion battery. In an alternative embodiment, the first electrode, 101, 201 and the second electrode, 102, 202 have the same material composition, and the multi-layer article 100, 200 hereof is useful in lithium-ion capacitors, particularly in that class of capacitors known as “electric double layer capacitors.”

In one embodiment the first electrode, 101, 201 comprises at least one of carbon, graphite, coke, lithium titanates, lithium-tin alloys, silicon, carbon-silicon composites, or mixtures thereof. In a further embodiment, the second electrode, 102, 202 comprises at least one of lithium cobalt oxide, lithium iron phosphate, lithium nickel oxide, lithium manganese phosphate, lithium cobalt phosphate, Li(Mn_{1/3} Ni_{1/3}CO_{1/3})O₂(MNC), Li(Ni_{1-y-z}Co_{y}Al_{z})O₂ (NCA), lithium manganese oxide, or mixtures thereof.

In one embodiment, the first electrode, 101, 201; the separator, 105, 205; and the second electrode, 102, 202 are in mutually adhering contact in the form of a laminate. In another embodiment, each electrode material is combined with one or more polymers and other additives to form a paste that is adheringly applied to a surface of the nanoweb separator, 105, 205 having two opposing surfaces. Pressure and/or heat can be applied to form an adhering laminate.

In a further embodiment of the multi-layer article, 200 at least one of the electrode is coated onto a non-porous metallic sheet that serves as a current collector. In a preferred embodiment, both electrodes are so coated. In the battery embodiments of the electrochemical cell hereof, the metallic current collectors comprise different metals. In the capacitor embodiments of the electrochemical cell hereof, the metallic current collectors comprise the same metal. The metallic current collectors suitable for use in the present invention are preferably metal foils.

In one embodiment wherein the multi-layer article, 200 is useful in lithium-ion batteries, the first electrode, 201 is a negative electrode material comprising graphite, an intercalating material for Li ions; the second electrode, 202 is a positive electrode material comprising lithium cobalt oxide; the separator 205 comprising a nanoweb comprising nanofibers of a cross-linked polyimide, disclosed herein above.

In a further embodiment, the multi-layer article, 200 comprises a first current collector, 211 comprising a copper foil in electrically conductive contact with the first electrode, 201; and a second current collector, 212 comprising an aluminum foil in electrically conductive contact with the second electrode, 201.

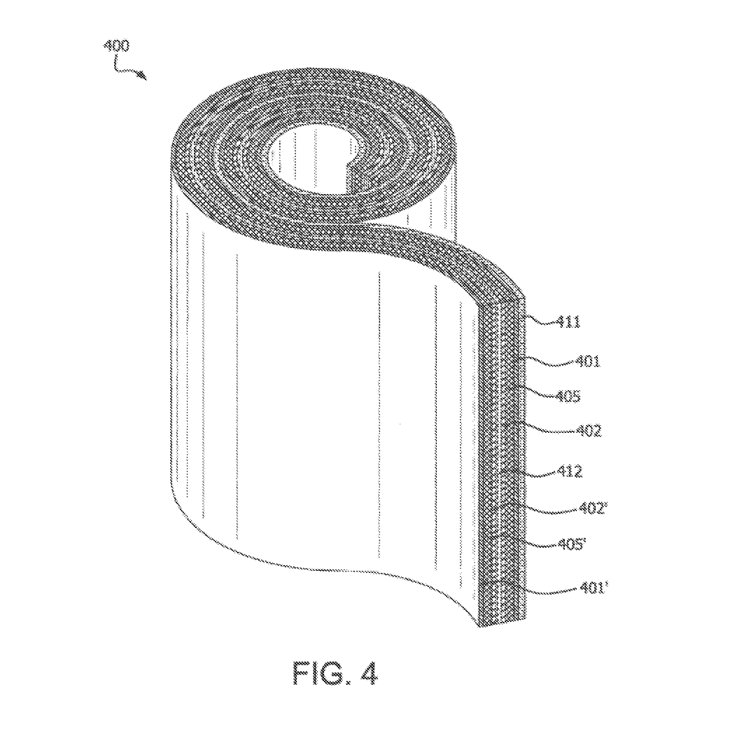

FIG. 3 schematic illustrates a perspective view of another embodiment of a multi-layer article, 300 of the present invention in the form of a prismatic stack. FIG. 4 schematic illustrates a perspective view of another embodiment of a multi-layer article, 400 of the present invention in the form of a spiral stack. The multi-layer article, 300, 400 comprise a first layer, 311, 411 comprising a first negative current collector; a second layer, 301, 401 comprising a first negative electrode in electrically conductive contact with the first layer, 311, 411; a third layer, 305, 405 comprising a first separator of the present invention; a fourth layer, 302, 402 comprising a first positive electrode in contact with the third layer; a fifth layer, 312, 412 comprising a first positive current collector in electrically conductive contact with the fourth layer, 302, 402; a sixth layer, 302′, 402′ comprising a second positive electrode in electrically conductive contact with the fifth layer, 312, 412; a seventh layer, 305′, 405′ comprising a second separator of the present invention in contact with the sixth layer, 302′, 402′; an eighth layer, 301′, 401′ comprising a second negative electrode in contact with the seventh layer, 305′, 405′. In an embodiment, one or more layers from the first layer to the eighth layer can be repeated. In a further embodiment, a last layer of the prismatic stack or the spiral stack of the multi-layer article 300, 400 comprises a positive current collector.

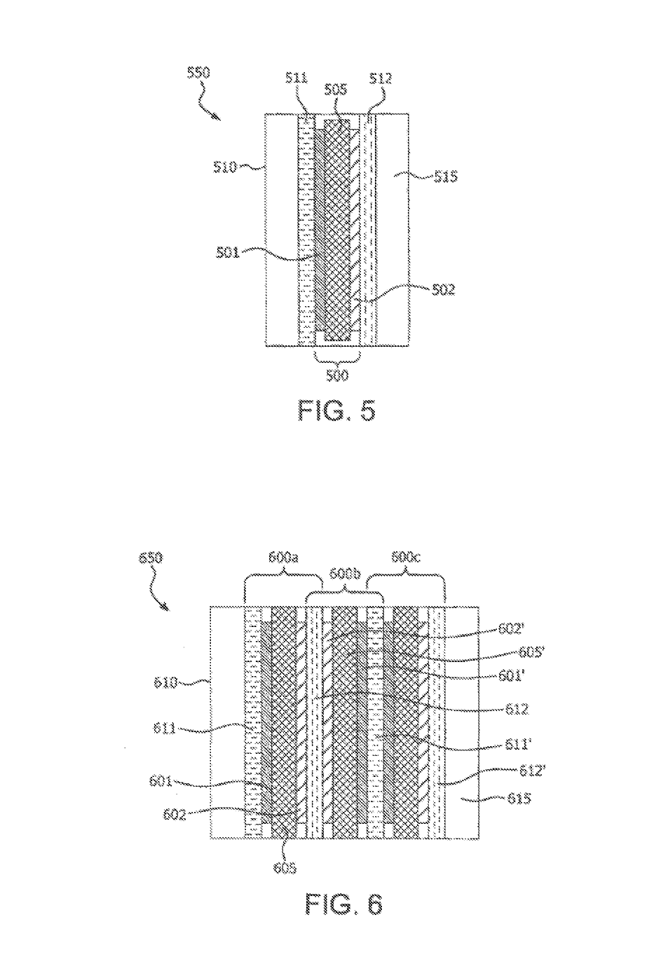

FIG. 5 schematically illustrates a cross-sectional view of an embodiment of an electrochemical cell, 550. The electrochemical cell, 550 comprises a housing, 510 having disposed therewithin, an electrolyte, 515, and a multi-layer article 500 at least partially immersed in the electrolyte, 515. The multi-layer article, 500 comprising a first electrode, 501, a second electrode, 502, and a separator, 505 as disclosed hereinabove, disposed between and in contact with the first electrode, 501 and the second electrode, 502 and wherein the first electrode, 501 and the second electrode, 502 are in ionically conductive contact with the electrolyte, 515. The electrochemical cell, 550 also comprises a first current collector, 511 in electrically conductive contact with the first electrode, 501 and a second current collector, 512 in electrically conductive contact with the second electrode, 502.

In one embodiment of the electrochemical cell, 550, the first current collector, 511 comprises a copper foil; the first electrode, 501 comprising graphite is in adhering contact with the copper foil; the separator 505 comprising a nanoweb comprising nanofibers of a cross-linked polyimide, disclosed herein above; the second electrode, 502 comprising lithium cobalt oxide is in adhering contact with the nanoweb of the separator, 505; and the second current collector, 512 comprising an aluminum foil is in adhering contact with lithium cobalt oxide.

In a further embodiment, the electrolyte, 515 is a liquid electrolyte comprising an organic solvent and a lithium salt soluble therein. In a further embodiment, the lithium salt is LiPF₆, LiBF₄, or LiClO₄. In a still further embodiment, the organic solvent comprises one or more alkyl carbonates. In a further embodiment, the one or more alkyl carbonates comprises a mixture of ethylene carbonate and dimethylcarbonate. The optimum range of salt and solvent concentrations may vary according to specific materials being employed, and the anticipated conditions of use; for example, according to the intended operating temperature. In one embodiment, the solvent is 70 parts by volume ethylene carbonate and 30 parts by volume dimethyl carbonate and the salt is LiPF₆.

Alternatively, the electrolyte, 515 may comprise a lithium salt such as, lithium hexafluoroarsenate, lithium bis-trifluoromethyl sulfonamide, lithium bis(oxalate)boronate, lithium difluorooxalatoboronate, or the Li⁺ salt of polyfluorinated cluster anions, or combinations of these. Alternatively, the electrolyte, 515 may comprise a solvent, such as, propylene carbonate, esters, ethers, or trimethylsilane derivatives of ethylene glycol or poly(ethylene glycols) or combinations of these. Additionally, the electrolyte, 515 may contain various additives known to enhance the performance or stability of Li-ion batteries, as reviewed for example by K. Xu in Chem. Rev., 104, 4303 (2004), and S. S. Zhang in J. Power Sources, 162, 1379 (2006).

Also present in the electrochemical cell, 550, but not shown, would be a means for connecting the cell to an outside electrical load or charging means. Suitable means include wires, tabs, connectors, plugs, clamps, and any other such means commonly used for making electrical connections.

FIG. 6 schematically illustrates a cross-sectional view of another embodiment of an electrochemical cell, 650 of the present invention. The electrochemical cell 650 comprises a stack of three multi-layer articles, 600a, 600b, 600c and an electrolyte, 615 disposed in a housing, 610. In particular, the electrochemical cell 650 comprises a first negative current collector, 611; a first negative electrode, 601 in electrically conductive contact with the first negative current collector, 611; a first separator, 605 of the present invention; a first positive electrode, 602 in contact with the first separator, 605, wherein the first positive electrode, 602 is in ionically conductive contact with the first negative electrode, 601; a first positive current collector, 612 in electrically conductive contact with the first positive electrode, 602; a second positive electrode, 602′ in electrically conductive contact with the first positive current collector, 612; a second separator, 605′ of the present invention, in contact with the second positive electrode 602′; a second negative electrode, 601′ in contact with the second separator, 605′, wherein the second negative electrode, 601′ is in ionically conductive contact with the second positive electrode, 602′; and so on, repeating one or more layers from the first negative current collector, 611, such that a last layer, 612′ comprises a positive current collector.

When the individual cells, 600a, 600b, 600c in the multi-layer stack, 600 are electrically connected to one another in series, positive to negative, the output voltage from the stack is equal to the combined voltage from each cell. When the individual cells, 600a, 600b, 600c making up the multi-layer stack, 600 are electrically connected in parallel, the output voltage from the stack is equal to the voltage of one cell. The average practitioner of the electrical art will know when a series arrangement is appropriate, and when a parallel.

The positive and negative electrodes in lithium-ion cells suitable for use in one embodiment of the present invention are similar in form to one another and are made by similar processes on similar or identical equipment. In one embodiment, active material is coated onto both sides of a metallic foil, preferably Al foil or Cu foil, which acts as current collector, conducting the current in and out of the cell. In one embodiment, the negative electrode is made by coating graphitic carbon on copper foil. In one embodiment, the positive electrode is made by coating a lithium metal oxide (e.g. LiCoO₂) on Al foil. In a further embodiment, the thus coated foils are wound on large reels and are dried at a temperature in the range of 100-150° C. before bringing them inside a dry room for cell fabrication.

The electrode thickness achieved after drying is typically in the range of 50-150 micrometers. In an embodiment, the one-side coated foil is fed back into the coating machine with the uncoated side disposed to receive the slurry deposition to produce a coating on both sides of the foil. In one embodiment, following coating on both sides, the electrodes so formed are then calendered and optionally slit to narrow strips for different size batteries. Any burrs on the edges of the foil strips could give rise to internal short circuits in the cells so the slitting machine must be very precisely manufactured and maintained.

Lithium-ion batteries are available in a variety of forms including cylindrical, prismatic, pouch, wound, and laminated. Lithium-ion batteries find use in a variety of different applications (e.g. consumer electronics, power tools, and hybrid electric vehicles). The manufacturing process for lithium-ion batteries is similar to that of other batteries such as NiCd and NiMH, but is more sensitive because of the reactivity of the materials used in lithium-ion batteries.

In an embodiment, the electrochemical cell, 550, 650 comprises the multi-layer article, 500, 600 in the form of a prismatic stack, for example, multi-layer article, 300 in prismatic form, as shown in the FIG. 3. In another embodiment, the electrochemical cell, 550, 650 comprises the multi-layer article, 500, 600 in the form of a spiral stack, for example, multi-layer article, 400 in spiral form, as shown in the FIG. 4.

To form the cylindrical embodiment of a Li-ion cell of the present invention, the electrode assembly is first wound into a spiral structure as depicted in FIG. 4. Then, a tab is applied to the edge of the electrode to connect the electrode to its corresponding terminal. In the case of high power cells it is desirable to employ multiple tabs welded along the edges of the electrode strip to carry the high currents. The tabs are then welded to the can and the spirally wound electrode assembly is inserted into a cylindrical housing. The housing is then sealed but leaving an opening for injecting the electrolyte into the housing. The cells are then filled with electrolyte and then sealed. The electrolyte is usually a mixture of salt (LiPF₆) and carbonate based solvents.

Cell assembly is preferably carried out in a “dry room” since the electrolyte reacts with water. Moisture can lead to hydrolysis of LiPF₆ forming HF, which can degrade the electrodes and adversely affect the cell performance.

After the cell is assembled it is formed (conditioned) by going through at least one precisely controlled charge/discharge cycle to activate the working materials. For most lithium-ion chemistries, this involves creating the SEI (solid electrolyte interface) layer on the negative (carbon) electrode. This is a passivating layer which is essential to protect the lithiated carbon from further reaction with the electrolyte.

In another aspect, the invention provides an electrochemical double layer capacitor (EDLC). EDLCs are energy storage devices having a capacitance that can be as high as several Farads. Charge storage in double layer electrochemical capacitors is a surface phenomenon that occurs at the interface between the electrodes, typically carbon, and the electrolyte. In the double layer capacitor hereof, the polyimide nanoweb hereof serves as a separator that absorbs and retains the electrolyte thereby maintaining close contact between the electrolyte and the electrodes. The role of the polyimide nanoweb hereof as the separator is to electrically insulate the positive electrode from the negative electrode and to facilitate the transfer of ions in the electrolyte, during charging and discharging. Electrochemical double layer capacitors are typically made in a cylindrically wound design in which the two carbon electrodes and separators are wound together, the polyimide nanoweb separators having high strength avoid short circuits between the two electrodes.

### Examples

### Polymer Preparation

Preparation of Acetylene end-capped Polyamic acid (PAA-AC) solutions 4,4′ oxydianiline (ODA), 98% purity (25.2302 g, 0.126 mol) (Sigma-Aldrich Corporation) was fully dissolved by stirring in 221 mL of N,N-dimethylformamide (DMF) (CHROMASOLV® Plus, Sigma-Aldrich Corporation) in a 500 mL glass kettle under nitrogen. The kettle was maintained under nitrogen purge for the duration of the reaction. Pyromellitic dianhydride (PMDA), 97% purity (26.65 g, 0.1222 mol, 97% stoichiometry relative to ODA) (Sigma-Aldrich) was then added to the kettle over a 5.5 hour period according to the following Table 2:

TABLE 2

| Time (hr) | Wt PMDA (g) | % of total PMDA charge |
|---|---|---|
| 0.0 | 6.1334 | 25 |
| 0.5 | 6.1334 | 25 |
| 1.5 | 6.1334 | 25 |
| 1.5 | 1.1467 | 5 |
| 2.5 | 1.1467 | 5 |
| 3.5 | 1.1467 | 5 |
| 4.5 | 1.1467 | 5 |
| 5.5 | 1.1467 | 5 |

Additional solvent (25 mL) was used to rinse any residual PMDA into the above reaction mixture. The reactants were stirred at room temperature for additional 16 hours. After 16 hrs of reaction time, the solution viscosity was measured with a Brookfield DV-1 viscometer in the reaction flask.

To end-cap the polymers, cross-linkable end-group 5-ethynyl isobenzofuran-1,3-dione (EPA, from TCI America), phenylethynyl phthalic anhydride (PEPA, from TCI America), or Phenylethynyl trimellitic anhydride (PETA from Nexam)] was added to the reaction mixture in a molar amount in the range of 0.06 to 0.14 relative to ODA and stirred for another 1.5 hours to form an acetylene end-capped polyamic acid (PAA-AC). The contents were then poured directly from the reaction vessel into jars, sealed, and placed in a −20° C. freezer for storage prior to electrospinning. Table 3 summarizes various end-capped polyamic acid solutions that were used to form polyamic acid nanowebs via electrospinning. For control, a solution of polyamic acid without an end-capper (PAA-1) was also made and is reported in Table 3.

TABLE 3
Polyamic acid solution formed with
varying amounts of monomers and end-cappers

| | | | | | Polymer | |
|---|---|---|---|---|---|---|
| | | Monomers (mole ratio) | | | Weight | |
| | | | | End- | % in | Viscosity |
| Sample # | End-capper | ODA | PMDA | capper | DMF | (Pa · s) |
| PAA-1 | N/A | 1.0 | 0.97 | 0 | 23 | 8.5 |
| (Control) | | | | | | |
| PAA-AC-1 | EPA | 1.0 | 0.93 | 0.14 | 25 | 4.2 |
| PAA-AC-2 | EPA | 1.0 | 0.97 | 0.06 | 20 | 8.4 |
| PAA-AC-3 | EPA | 1.0 | 0.89 | 0.11 | 30 | 12.0 |
| PAA-AC-4 | PEPA | 1.0 | 0.88 | 0.12 | 29 | 11.2 |
| PAA-AC-5 | PETA | 1.0 | 0.88 | 0.12 | 29 | 10.9 |

Table 4 shows effect of monomer stoichiometry, as it is changed from 93% to 98% on the molecular weight of the non end-capped polyamic acid formed. After reacting for 16 hrs and prior to end-capping, solution aliquots were transferred to scintillation vials and their molecular weight was determined by GPC. As used herein, the term “93% stoichiometry” refers to the amount of PMDA relative to ODA. Thus, a polyamic acid having a 93% stoichiometry was made using PMDA and ODA in the amounts of PMDA:ODA:: 0.93:1.

TABLE 4
Effect of monomer stoichiometry on the molecular weight of the non
end-capped polyamic acid

| Sample Name | Mn (g/mol) | Mw (g/mol) | Mw/Mn |
|---|---|---|---|
| 93% stoichiometry | 4,560 | 11,035 | 2.42 |
| 95% stoichiometry | 7,073 | 16,649 | 2.35 |
| 96% stoichiometry | 8,992 | 19,224 | 2.14 |
| 97% stoichiometry | 22,908 | 34,295 | 2.08 |
| 98% stoichiometry | 19,331 | 40,695 | 2.11 |

### Nanoweb Preparation

### Preparation of Acetylene End-Capped Polyamic Acid Nanoweb (PAA-AC-NW)

The PAA solutions (100 mL) prepared supra and summarized in Table 2 were electroblown into a fibrous web according to the process described in U.S. Published Patent Application No. 2005/0067732, hereby incorporated herein in its entirety by reference. The resulting polyamic acid nanowebs were about 20 microns thick with a porosity of about 60% and with a mean average fiber diameter of 600 nm. The nanowebs were then manually unwound and cut with a manual rolling blade cutter into hand sheets approximately 30.5 cm (12″) long and 25.4 cm (10″) wide.

### Preparation of Cross-Linked Polyimide Nanoweb (PI-AC-NW)

Acetylene end-capped polyamic acid nanoweb (PAA-AC-NW) prepared supra were imidized at 350° C. and annealed at 450° C. in a convection oven under air atmosphere at various times, as given in Table 4 to form acetylene end-capped polyimide nanoweb (PI-AC-NW).

### Mechanical Testing of Cross-Linked Polyimide Nanoweb (PI-AC-NW)

Following heating, each sample was cut into 1.27 cm by 12.7 cm (0.5″ by 5″) strips and tested for break load, according to ISO 9073-3, using an Instron machine. Samples were loaded into the Instron machine and pulled with a crosshead speed of ten inches per minute. Stress-strain curves were analyzed for break load, which was converted into break stress by dividing by the cross-sectional area of each sample. The thickness of each sample was measured with a Mitutoyo Digimatic (Series 293) Micrometer. The Break stress data reported in Table 5 represents mean of at least three sample runs.

TABLE 5
Heating profile and break stress of acetylene end-capped polyimide
nanowebs

| | | | Imidi- | | |
|---|---|---|---|---|---|
| | | Stoi- | zation | Annealing | |
| | | chi- | at 350° C. | at 450° C. | Break |
| | Polymer | ome- | for time | for time | Stress |
| Sample | solution | try | (min) | (min) | (Kg/cm²) |
| PI-Control-1 | PAA-1 | 97% | 2 | 5 | 360 ± 50 |
| PI-AC-NW-1-1 | PAA-AC-1 | 93% | 2 | 0 | 130 ± 25 |
| PI-AC-NW-1-2 | | | 2 | 5 | 500 ± 25 |
| PI-AC-NW-1-3 | | | 2 | 10 | 320 ± 25 |
| PI-AC-NW-1-4 | | | 5 | 2 | 200 ± 25 |
| PI-AC-NW-1-5 | | | 10 | 2 | 200 ± 25 |
| PI-AC-NW-1-6 | | | 20 | 2 | 225 ± 25 |
| PI-AC-NW-2 | PAA-AC-2 | 97% | 2 | 5 | 425 ± 25 |
| PI-AC-NW-3 | PAA-AC-3 | 89% | 2 | 5 | 400 ± 50 |
| PI-AC-NW-4 | PAA-AC-4 | 88% | 2 | 5 | 360 ± 50 |

Table 5 shows that imidization and annealing protocols have a significant impact on the strength of polyimide nanowebs which were end-capped with cross-linkable groups. Comparing PI-AC-NW-1-1 with PI-AC-NW-1-2 shows that upon addition of an annealing step (450° C. for 5 min) to the imidization step (350° C. for 2 min), the break stress of the sample increased by 300%.

Comparing end-capped polyimide nanowebs (PI-AC-NW-1-2, PI-AC-NW-3, and PI-AC-NW-4) having stoichiometry in the range of 88-93% with PI-Control-1 having stoichiometry of 97%, shows nanowebs with comparable strengths can be obtained starting with lower stoichiometry and hence lower molecular weight if imidized and annealed under optimum conditions.

### Characterization of Cross-Linked PI Nanoweb (PI-AC-NW-3)

The infrared spectrum of PI-AC-NW-3 (FIG. 8) was collected and compared to PI-Control-1 (FIG. 7). Infrared spectra were collected on a Bruker Alpha infrared spectrometer with diamond ATR attachment. In the spectrum for PI-AC-NW-3, the peak at 1110 cm⁻¹, which corresponds to the in-plane bending of para-substituted benzene rings, is decreased in intensity when compared to the spectrum of PI-Control-1. When the material is end-capped and cross-linked, the cross-link points become 1,3,5 trisubstituted benzene rings, which do not absorb in this region. The peak height ratio of this peak to a control background peak at 1500 cm⁻¹ decreases by approximately 30% in the spectrum of PI-AC-NW-3 compared to PI-Control-1. In addition, a peak at 700 cm-¹ (which is representative of ring bending for 1,3,5 substituted aromatics) develops as a shoulder in the spectrum of PI-AC-NW-3. The peak height ratio of this shoulder (compared to the background peak at 1500 cm⁻¹) increased by approximately 50% in the spectrum of PI-AC-NW-3 compared to PI-Control-1.

### Assembly of Lithium-Ion Coin Cells (CR2032)

Samples of the polyimide nanowebs were dried overnight at 90° C. in a vacuum chamber. The thus dried specimens were incorporated into electrochemical coin cells.

Li-ion coin cells (CR2032) were assembled to evaluate the cell performance in an Ar glove box from dried components as follows. The anode comprised natural graphite coated on Cu and cathode comprised a layer of LiCoO₂ coated on Al foil, both obtained from Pred Materials International (New York, N.Y.). The electrolyte comprised 1 Molar LiPF₆ in a 70:30 mixture of ethyl methyl carbonate and ethylene carbonate obtained from Ferro Corporation (Cleveland, Ohio). The cell can was obtained from Farasis Energy, Inc (Hayward, Calif.). In the Li-ion coin cells, the anode and the cathode were separated by a single layer of cross-linked polyimide nanoweb of Example PI-AC-NW-1-2 (stoichiometry 93%) and of Example PI-AC-NW-4 (stoichiometry 89%). Another Li-ion coin cell for comparison was made with the anode and the cathode separated by a single layer of control sample PI-Control-1 (stoichiometry 97%) formed from polyamic acid without an end-capper (PAA-1).

### Evaluation of Cell Performance of Lithium-Ion Coin Cells (CR2032)

The as-prepared Li-ion coin cells containing either a single layer of cross-linked polyimide nanoweb separator (PI-AC-NW-1-2 or PI-AC-NW-4) or a single layer control sample PI-Control-1 were attached to a battery tester, Series 4000 (Maccor Inc., Tulsa, Okla.).

Cell performance of the cross-linked polyimide nanoweb separators and the control polyimide separator was evaluated by cycling the cells at 1C rate for 50 cycles with charge and discharge time of one hour each. Table 6 summarizes the cycling performance of the cross-linked polyimide nanowebs and also the control sample.

TABLE 6
Cell performance during cycling

| | | | Fiftieth |
|---|---|---|---|
| | First Cycle | Third Cycle | Cycle |
| | Discharge | Discharge | Discharge |
| | Capacity | Capacity | Capacity |
| Sample | (mAh) | (mAh) | (mAh) |
| PI-control-1 | 2.91 ± 0.1 | 2.85 ± 0.1 | 2.45 ± 0.1 |
| PI-AC-NW-1-2 | 2.94 ± 0.1 | 2.87 ± 0.1 | 2.51 ± 0.2 |
| PI-AC-NW-4 | 2.92 ± 0.1 | 2.85 ± 0.1 | 2.47 ± 0.2 |

Table 6 shows that within experimental error, the cross-linked polyimide separator performed equivalently to the polyimide control sample formed from polyamic acid without an end-capper.

What is claimed is:

1. An electrochemical cell comprising:
(a) an electrolyte;
(b) a multi-layer article, the multi-layer article comprising a first electrode, a second electrode in ionically conductive contact with the first electrode, and a separator disposed between and in contact the first electrode and the second electrode, the separator comprising:
a nanoweb, the nanoweb comprising nanofibers of a cross-linked polyimide,
wherein the cross-linked polyimide is derived from an aromatic dianhydride, an aromatic diamine, and a reactive end-capper;
(c) a first current collector in electrically conductive contact with the first electrode; and
(d) a second current collector in electrically conductive contact with the second electrode.

2. The electrochemical cell of claim 1, wherein the aromatic dianhydride is selected from the group consisting of pyromellitic dianhydride (PMDA), biphenyltetracarboxylic dianhydride (BPDA), and 3,3′,4,4′-benzophenone tetracarboxylic dianhydride (BTDA), and mixtures thereof.

3. The electrochemical cell of claim 1, wherein the aromatic diamine is selected from the group consisting of oxydianiline (ODA), 1,3-bis(4-aminophenoxy)benzene (RODA), 1,4 phenelenediamine (PDA), and mixtures thereof.

4. The electrochemical cell of claim 1, wherein the reactive end-capper is at least one of a functionalized anhydride or a functionalized amine, functionalized with a reactive functionality selected from the group consisting of acetylene, vinyl, epoxide, nitrile, and ester.

5. The electrochemical cell of claim 1, wherein the reactive end-capper is an acetylene-functionalized phthalic anhydride.

6. The electrochemical cell of claim 5, wherein the acetylene-functionalized phthalic anhydride is selected from the group consisting of 4-phenylethynylphthalic anhydride (PEPA), ethynyl phthalic anhydride (EPA), pyromellitic ethynyl phthalic anhydride (PETA), methyl ethynyl phthalic anhydride (MEPA), and mixtures thereof.

7. The electrochemical cell of claim 5, wherein the cross-linked polyimide comprises a cyclotrimerized aromatic polyimide.

8. The electrochemical cell of claim 1, wherein the cyclotrimerized aromatic polyimide has the following general structure: 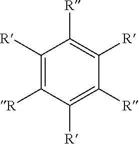
wherein R″ comprises at least one of hydrogen, methyl, phenyl, or phthalic anhydride and R′ comprises at least one of: 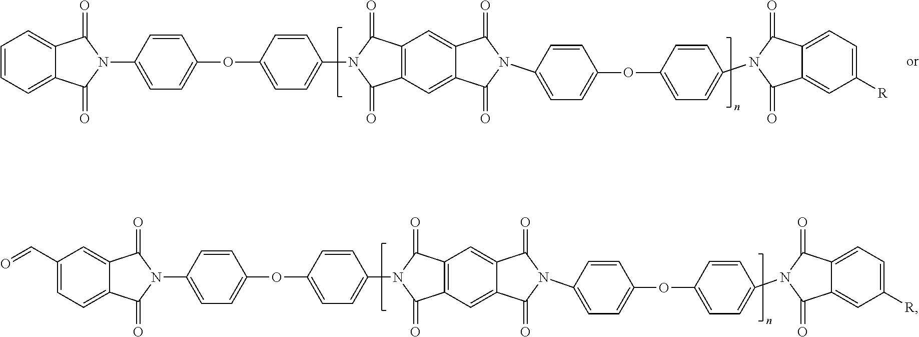
wherein R comprises at least one of, acetylene, etyhynyl benzene, 3-phenyl-2-propynal, ethynyl phthalic anhydride, or propyne.

9. The electrochemical cell of claim 7, wherein the cyclotrimerized aromatic polyimide comprises at least one of 1,3,5-tripolyimide benzene; 1,3,5-tripolyimide-2,4,6-triphenyl benzene; 1,3,5-tripolyimide-2,4,6-trimethyl benzene; 1,3,5-tripolyimide-2,4,6-(isobenzofuran-1,3-dione); or mixtures thereof.

10. The electrochemical cell of claim 5, wherein the cross-linked polyimide is derived from an aromatic dianhydride, an aromatic diamine, and an acetylene-functionalized phthalic anhydride present in a molar ratio of 0.85:1.0:0.30 to 0.95:1.0:0.01.

11. The electrochemical cell of claim 5, wherein the cross-linked polyimide is derived from an aromatic dianhydride, an aromatic diamine, and an acetylene-functionalized phthalic anhydride present in a molar ratio of 0.88:1.0:0.24 to 0.95:1.0:0.02.

12. The electrochemical cell of claim 10, wherein the break stress of the nanoweb is at least 200 Kg/cm².

13. The electrochemical cell of claim 10, wherein the break stress of the nanoweb is at least 330 Kg/cm².

14. The electrochemical cell of claim 1, wherein the first electrode is a negative electrode comprising at least one of carbon, graphite, coke, lithium titanates, lithium-tin alloys, silicon, carbon-silicon composites, or mixtures thereof.

15. The electrochemical cell of claim 1, wherein the second electrode is a positive electrode comprising at least one of lithium cobalt oxide, lithium iron phosphate, lithium nickel oxide, lithium manganese phosphate, lithium cobalt phosphate, Li(Mn_{1/3} Ni_{1/3}CO_{1/3})O₂(MNC), Li(Ni_{1-y-z}Co_{y}Al_{z})O₂ (NCA), lithium manganese oxide, or mixtures thereof.

16. The electrochemical cell of claim 1, wherein the first electrode and the second electrode have the same material composition.

17. The electrochemical cell of claim 1, wherein the lithium-ion electrochemical cell is a lithium-ion battery.

18. The electrochemical cell of claim 1, wherein the lithium-ion electrochemical cell is a lithium-ion capacitor.

19. The electrochemical cell of claim 1, wherein the nanofibers characterized by a number average diameter of less than 1000 nm.

20. The electrochemical cell of claim 1, wherein the nanofibers are characterized by a number average diameter in the range of 50-800 nm.

21. The electrochemical cell of claim 1, wherein the nanofibers are characterized by a number average diameter in the range of 100-400 nm.

22. The electrochemical cell of claim 1, further comprising a means for connecting the electrochemical cell to an outside electrical load or charging means.
